(19) United States
(12) Patent Application Publication
(10) Pub. No.: US 2004/0245813 A1
(43) Pub. Date: Dec. 9, 2004

(54) Apparatus with actuatable tether for resisting rearward pivotal movement of a backrest portion of a seat

(75) Inventor: Charles E. Steffens JR., Washington, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/455,703

(22) Filed: Jun. 5, 2003

(51) Int. Cl. B60N 2/42

(52) U.S. Cl. 297/216.1

(57) ABSTRACT

An apparatus (8) includes a seat (10) for an occupant (12) of a vehicle (14). The seat (10) includes a cushion portion (16) and a backrest portion (18). A pivot mechanism (50) pivotally connects the backrest portion (18) to the cushion portion (16) and enables pivotal movement of the backrest portion (18) relative to the cushion portion (16) in both forward and rearward directions. The apparatus (8) also includes an occupant protection device (70) that is actuatable in response to an occupant exerted force directed rearward against the backrest portion (18) of the seat (10). The occupant protection device (70), when actuated resists rearward pivotal movement of the backrest portion (18) of the seat (10) relative to the cushion portion (16) of the seat (10).

### TECHNICAL FIELD

The present invention relates to an apparatus with an actuatable tether for resisting rearward pivotal movement of a backrest portion of a seat.

### BACKGROUND OF THE INVENTION

A conventional seat for an occupant of a vehicle includes a cushion portion and a backrest portion. The cushion portion of the seat is attached to the vehicle body, generally through rails. The cushion portion of the seat supports the backrest portion of the seat. In many conventional designs, a pivot mechanism attaches the backrest portion to the cushion portion and enables pivotal movement of the backrest portion of the seat relative to the cushion portion in both a forward and rearward direction.

During a rear impact to the vehicle, relative movement between the occupant and the vehicle results in a force being applied by the occupant against the backrest portion of the seat. In order to restrain the occupant in the seat during the rear impact, the pivot mechanism of the seat must resist movement of the backrest portion of the seat relative to the cushion portion of the seat in response to the force applied by the occupant against the backrest portion of the seat.

The force applied by the occupant against the backrest portion of the seat results in a torque about the pivot mechanism that tends to rotate the backrest portion of the seat rearward relative to the cushion portion of the seat. The occupant loading can overwhelm the seat structure or the seat latch assembly associated with the pivot mechanism. It would be desirable, therefore, to find a technique for effectively supporting the backrest portion of a seat relative to a cushion portion of a seat during a rear impact to the vehicle.

### SUMMARY OF THE INVENTION

The present invention relates to an apparatus comprising a seat for an occupant of a vehicle. The seat comprises a cushion portion and a backrest portion. A pivot mechanism pivotally connects the backrest portion to the cushion portion and enables pivotal movement of the backrest portion relative to the cushion portion in both forward and rearward directions. The apparatus also comprises an occupant protection device that is actuatable in response to an occupant exerted force directed rearward against the backrest portion of the seat. The occupant protection device, when actuated, provides a forwardly directed force acting on the backrest portion of the seat to resist rearward pivotal movement of the backrest portion of the seat relative to the cushion portion of the seat.

According to a second aspect, the present invention relates to an apparatus comprising a seat for an occupant of a vehicle. The seat includes a cushion portion having a cushion frame that is mounted to the vehicle and a backrest portion having a backrest frame that is pivotally supported relative to the cushion frame for enabling forward and rearward pivotal movement of the backrest frame relative to the cushion frame. The apparatus also comprises a tether having opposite ends attached to the cushion frame and the backrest frame, respectively. The tether has a first condition extending along a first route between the cushion frame and the backrest frame and a second condition extending along a second route between the cushion frame and the backrest frame. The tether, in the second condition, resists rearward pivotal movement of the backrest frame relative to the cushion frame resulting from a rearward force applied to the backrest portion.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a perspective view of an apparatus constructed in accordance with the present invention and including a seat for an occupant of a vehicle and an actuatable occupant protection device in an unactuated condition;

FIG. 2 is a perspective view of the apparatus of the present invention with the actuatable occupant protection device in an actuated condition;

FIG. 3 is a side view of the apparatus of the present invention and illustrates an occupant located in the seat with the actuatable occupant protection device in an unactuated condition;

FIG. 4 is an enlarged view of the apparatus of FIG. 3;

FIG. 5 is a side view of the apparatus of the present invention and illustrates an occupant located in the seat with the actuatable occupant protection device moving between an unactuated condition and an actuated condition;

FIG. 6 is a side view of the apparatus of the present invention and illustrates an occupant located in the seat with the actuatable occupant protection device in an actuated condition;

FIG. 7 is an enlarged view of the apparatus of FIG. 6; and

FIG. 8 is a side view of an apparatus constructed in accordance with a second embodiment of the present invention and including a seat for an occupant of a vehicle and an actuatable occupant protection device in an actuated condition.

### DETAILED DESCRIPTION OF THE INVENTION

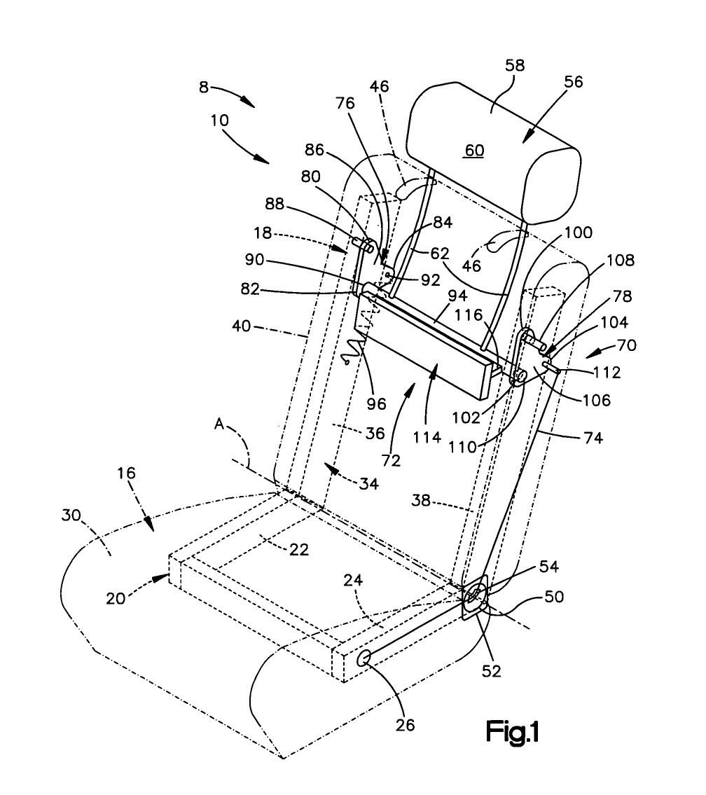

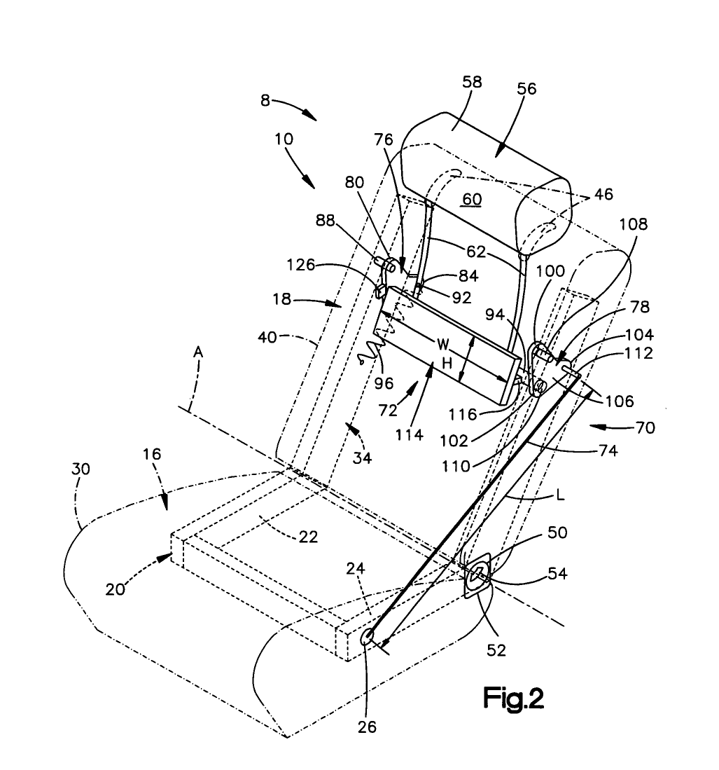

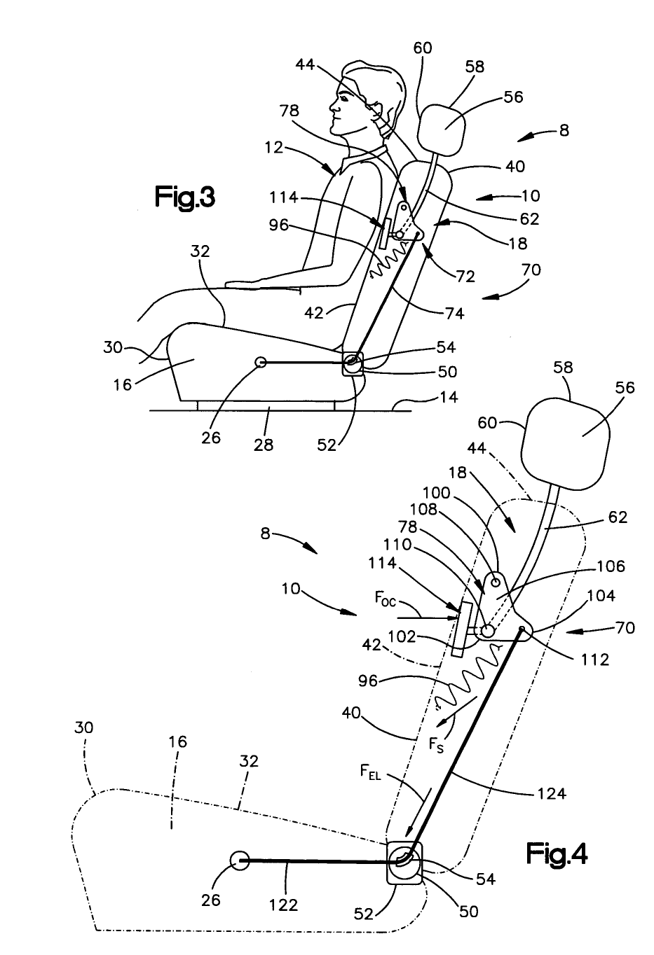

FIG. 1 is a perspective view of an apparatus 8 constructed in accordance with the present invention. The apparatus 8 includes a seat 10 for an occupant 12 (FIG. 3) of a vehicle 14. The seat 10 includes cushion portion 16 and a backrest portion 18. The cushion portion 16 includes a cushion frame 20. The cushion frame 20 is shown by dashed lines in FIGS. 1 and 2 and, for clarity of illustrating other parts of the seat 10, is not shown in FIGS. 3-8. The cushion frame 20 includes right and left frame members 22 and 24, respectively. An anchor 26 is attached to or, alternatively, formed on an outer surface of the left frame member 24.

As shown schematically in FIG. 3, the cushion frame 20 is mountable to the vehicle 14 through rails 28. The rails 28 support the cushion portion 16 of the seat 10 relative to the vehicle 14 and enable forward and rearward movement, to the left and right, respectively, as shown in FIG. 3, of the cushion portion relative to the vehicle. The cushion portion 16 also includes a covering 30. The covering 30 includes an upper surface 32 (FIG. 3) that the occupant 12 of the seat 10 engages.

The backrest portion 18 of the seat 10 includes a backrest frame 34. The backrest frame 34 is shown by dashed lines in FIGS. 1 and 2 and, for clarity of illustrating other parts of the seat 10, is not shown in FIGS. 3-8. The backrest frame 34 includes right and left frame members 36 and 38, respectively. The backrest portion 18 of the seat 10 also includes a covering 40. The covering 40 of the backrest portion 18 includes a front surface 42 (FIG. 3) that the occupant 12 of the seat 10 engages and an upper surface 44. As shown in FIGS. 1 and 2, two elongated slots 46 extend though the upper surface 44 of the covering 40 in the backrest portion 18 of the seat 10. Stitching (not shown) in the upper surface 44 of the covering 40 adjacent to the elongated slots 46 may be used to prevent tearing of the covering.

A pivot mechanism 50 pivotally attaches the backrest portion 18 of the seat 10 to the cushion portion 16 of the seat. The pivot mechanism 50 pivotally connects the right frame member 36 of the backrest portion 18 to the right frame member 22 of the cushion portion 16 and also pivotally connects the left frame member 38 of the backrest portion to the left frame member 24 of the cushion portion Thus, the cushion portion 16 of the seat 10 pivotally supports the backrest portion 18 of the seat via the pivot mechanism 50.

The pivot mechanism 50 enables pivotal movement of the backrest portion 18 of the seat 10 relative to the cushion portion 16 of the seat in both forward and rearward directions about pivot axis A (FIGS. 1 and 2). The forward direction of pivotal movement is counter-clockwise as shown in FIG. 3 and the rearward direction of pivotal movement is clockwise as shown in FIG. 3.

Preferably, the pivot mechanism 50 includes a latch mechanism (not shown) that limits the rearward pivotal movement of the backrest portion 18 of the seat 10 relative to the cushion portion 16 to a selected angle. The latch mechanism includes an actuator (not shown) that enables the occupant 12 of the seat 10 to select the angle at which rearward pivotal movement will be limited.

Plastic pivot covers overlie the outboard ends of the pivot mechanism 50. The plastic covers prevent access by the occupant 12 to the moveable parts of the pivot mechanism 50. FIG. 3 illustrates a generally square plastic cover 52 overlying an outboard end of the pivot mechanism 50 on the left side of the seat 10. The plastic pivot cover 52 for the left side of the seat 10 includes an outwardly extending elbow 54. The elbow 54 is located on the plastic pivot cover 52 in a location corresponding to the pivotal axis A of the pivot mechanism 50.

The seat 10 also includes a headrest portion 56 located above the backrest portion 18 of the seat 10. The headrest portion 56 is supported relative to the backrest portion 18 of the seat 10 in a manner that will be described below. A covering 58 envelops the headrest portion 56. The covering 58 includes a front surface 60 that is adapted to be engaged by a rear surface of the head of an occupant 12 of the seat 10. The headrest portion 56 also includes two support arms 62. The support arms 62 of the headrest portion 56 extend downwardly from the headrest portion and into the slots 46 on the upper surface 44 of the covering 40 of the backrest portion 18. The support arms 62 of the headrest portion 56 may have fixed lengths for fixing the position of the headrest portion above the upper surface 44 of the covering 40 of the backrest portion 18. Alternatively, the support arms 62 may include telescoping portions that enable adjustment of the position of the headrest portion 56 above the upper surface 44 of the covering 40 of the backrest portion 18.

The apparatus 8 also includes an occupant protection device 70 that is actuatable in response to a force directed against the front surface 42 of the covering 40 of the backrest portion 18 of the seat 10. The occupant protection device 70 includes a deflection mechanism 72 and a tether 74.

The deflection mechanism 72 includes right and left cranks 76 and 78, respectively. The right and left cranks 76 and 78 shown in FIGS. 1-8 are bell cranks. The right crank 76, shown in FIGS. 1 and 2, includes three vertices. The three vertices include an upper vertex 80, a lower front vertex 82, and a lower rear vertex 84. The right crank 76 also includes an inboard side and an outboard side. FIGS. 1 and 2 only show the inboard side 86 of the right crank 76.

A pivot pin 88 extends outwardly of the outboard side of the right crank 76 from a location near the upper vertex 80. The pivot pin 88 is adapted to connect pivotally the right crank 76 to the right frame member 36 of the backrest portion 18 of the seat 10.

The right crank 76 also includes two apertures. A first aperture 90 is located near the lower front vertex 82 of the right crank 76 and a second aperture 92 is located near the lower rear vertex 84 of the right crank. The first aperture 90 is adapted to support a first end of a support bar 94 of the deflection mechanism 72. The second aperture 92 is adapted to receive a first end of a biasing member 96.

The left crank 78 is a similar to the right crank 76. The left crank 78 also includes three vertices. The three vertices of the left crank 78 include an upper vertex 100, a lower front vertex 102, and a lower rear vertex 104. The left crank 78 also includes an inboard side and an outboard side. FIGS. 1 and 2 only show the outboard side 106 of the left crank 78.

A pivot pin 108 extends outwardly of the outboard side 106 of the left crank 78 from a location near the upper vertex 100. The pivot pin 108 is adapted to connect pivotally the left crank 78 to the left frame member 38 of the backrest portion 18 of the seat 10.

The left crank 78 also includes an aperture 110 near the lower front vertex 102. The aperture 110 is adapted to support a second end of the support bar 94 of the deflection mechanism 72.

A tether pin 112 extends outwardly of the outboard side 106 of the left crank 78 from a location near the lower rear vertex 104. The tether pin 112 has a length that is greater than the length of the pivot pin 108. As a result, when the second crank 78 is pivotally connected to the left frame member 38 of the backrest portion 18, the tether pin 112 extends from a position inside an inboard edge of the left frame member to a position outside of an outboard edge of the left frame member.

The support bar 94 illustrated in FIGS. 1 and 2 is a cylindrical rod having opposite first and second ends. The first end of the support bar 94 is received in the first aperture 90 in the lower front vertex 82 of the right crank 76 and to be fixedly secured to the right crank. The second end of the support bar 94 is received in the aperture 110 in the lower front vertex 102 of the left crank 78 and to be fixedly secured to the left crank.

The two support arms 62 of the headrest portion 56 of the seat 10 are fixedly attached to the outer surface of the support bar 94. The support arms 62 of the headrest portion 56 extend rearward and upward away from the support bar 94, as shown in FIGS. 3 and 4.

The deflection mechanism 72 also includes a deflection plate 114 that is attached to the support bar 94 via a spacer member 116 (FIGS. 1 and 2). The deflection plate 114 is rectangular and, as shown in FIG. 2, is defined by a width W and a height H. The width W of the deflection plate 114 is sized to be smaller than a distance between the inboard edges of the right and left frame members 36 and 38 of the backrest portion 18. The width W is also sized to extend across a majority of the distance between the inboard edges of the right and left frame members 36 and 38 of the backrest portion 18. The deflection plate 114 illustrated in FIGS. 1 and 2 has a width W that is approximately eighty-five percent of the distance between the inboard edges of the right and left frame members 36 and 38. The height H of the deflection plate 114 illustrated in FIGS. 1 and 2 is approximately one-third of the width W of the deflection plate.

The deflection plate 114 illustrated in FIGS. 1 and 2 is generally planar. Alternatively, the deflection plate 114 may be curved so as to conform to a front surface 42 of the covering 40 of the backrest portion 18 of the seat 10.

The spacer member 116 of the deflection mechanism 72 is fixedly attached to the outer surface of the support bar 94 and to the deflection plate 114. The spacer member 116 extends forwardly from the support bar 94 and supports the deflection plate 114. The spacer member 116 is dimensioned to position the deflection plate 114 of the deflection mechanism 72 near the front surface 42 of the covering 40 of the backrest portion 18 of the seat 10.

The deflection mechanism 72 also includes a biasing member 96. The biasing member 96 illustrated is a spring having opposite first and second ends. The first end of the spring 96 is received in the second aperture 92 of the right crank 76 and to be secured to the right crank. The second end of the spring 96 is received in an aperture in the right frame member 36 of the backrest portion 18 and to be secured to the right frame member.

The tether 74 of the occupant protection device 70 of the apparatus 8 is a flexible member made from a high strength material, such as webbing. Preferably, the tether 74 is made from a material having a web construction with energy absorbing characteristics. The energy absorbing characteristics help to reduce rebound of the occupant that may result from the tether 74 resisting rearward movement of the backrest portion 18 of the seat 10 relative to the cushion portion 16 of the seat. As an alternative to webbing, the tether 74 may be made from a braided metal cable or any other flexible member.

The tether 74 has opposite first and second ends. A length L, shown in FIG. 2, of the tether 74 is defined between the first and second ends. The first end of the tether 74 is secured to the tether pin 112 of the left crank 78 of the deflection mechanism 72. The second end of the tether 74 is secured to the anchor 26 on the left frame member 24 of the cushion portion 16 of the seat 10.

The occupant protection device 70 has an unactuated condition and an actuated condition. FIG. 1 is a perspective view of the apparatus 8 with the occupant protection device 70 in the unactuated condition. FIG. 2 is a perspective view of the apparatus 8 with the occupant protection device 70 in the actuated condition.

FIGS. 3 and 4 illustrate side views of the apparatus 8 with the occupant protection device 70 in the unactuated condition. When the occupant protection device 70 is in the unactuated condition, the deflection mechanism 72 is in a first position relative to the seat 10. The spring 96 urges the deflection mechanism 72 toward the first position. In the first position, the deflection plate 114 of the deflection mechanism 72 is positioned in the seat 10 adjacent to the front surface 42 of the covering 40 of the backrest portion 18. When an occupant 12 of the seat 10 leans against or is pressed against the backrest portion 18 of the seat, as shown in FIG. 3, a force is exerted against the deflection plate 114. The occupant exerted force against the deflection plate is indicated in FIGS. 4, 6, and 7 as F_{OC}. The occupant exerted force F_{OC} is transferred through the deflection plate 114, the spacer member 116, and the support bar 94 to the right and left cranks 76 and 78. The occupant exerted force F_{OC} tends to rotate the deflection mechanism 72 in a counter-clockwise direction, as shown in FIGS. 3 and 4, about the pivot pins 88 and 108 of the right and left cranks 76 and 78, respectively, and relative to the frame 34 of the backrest portion 18 of the seat 10. Thus, the occupant exerted force F_{OC} tends to rotate the deflection mechanism 72 away from the first position relative to the seat 10.

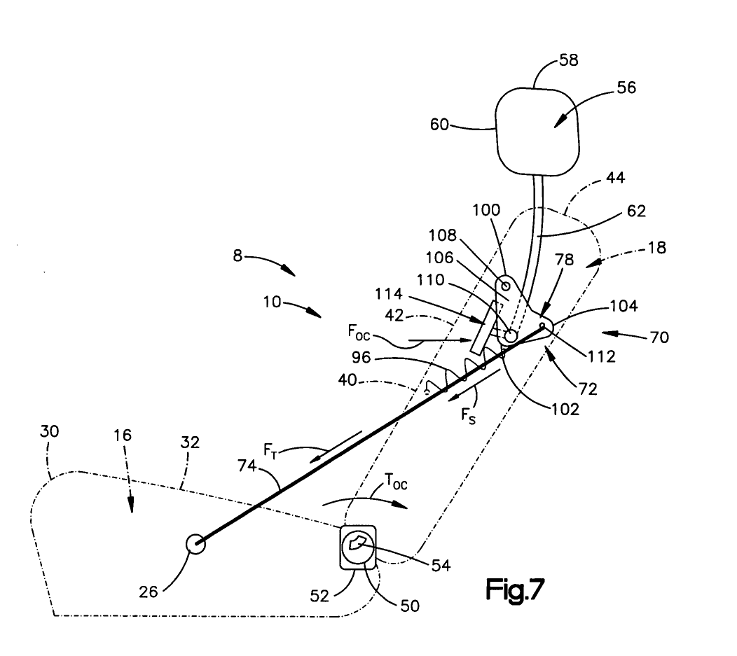

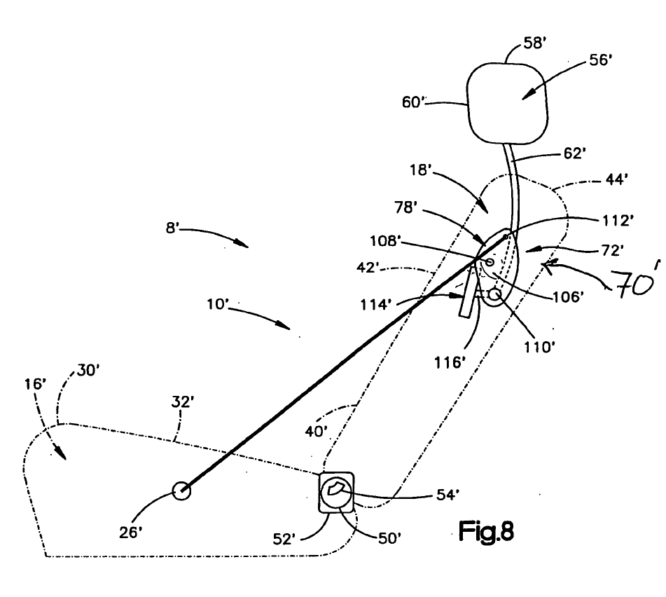

The spring 96 exerts a force, indicated as F_{S}, in FIGS. 4 and 7, on the right crank 76 of the deflection mechanism 72 that tends to rotate the deflection mechanism in a clockwise direction, as shown in FIGS. 3 and 4. Thus, the spring force F_{S} resists rotation of the deflection mechanism 72 away from the first position. The spring force F_{S} is chosen so as to resist counter-clockwise rotation of the deflection mechanism 72 in response to normally expected occupant exerted forces. Normally expected occupant exerted forces against the backrest portion 18 of the seat 10 have a magnitude that is not indicative of a rear impact to the vehicle 14. Examples of normally expected occupant exerted forces include the forces arising from the occupant 12 becoming seated upon the seat 10 and the forces arising from the occupant 12 shifting in the seat 10.

Since the support arms 62 of the headrest portion 56 of the seat 10 are attached to the support bar 94 of the deflection mechanism 72, the position of the deflection mechanism 72 affects the positioning of the headrest portion 56 relative to the backrest portion 18 of the seat 10. When the deflection mechanism 72 is in the first position, the headrest portion 56 is positioned above the upper surface 44 of the covering 40 of the backrest portion 18 and slightly rearward, to the right as shown in FIG. 3, of the front surface 42 of the covering of the backrest portion. Thus, when the deflection mechanism 72 is in the first position, the headrest portion 56 of the seat 10 is generally spaced away from the head of a properly seated occupant 12, as shown in FIG. 3.

When the occupant protection device 70 is in the unactuated condition, i.e., the deflection mechanism 72 is in the first position, the tether 74 extends along a first route between the anchor 26 and the tether pin 112. The first route is an indirect route between the anchor 26 and the tether pin 112. When extending along the first route, the tether 74 includes a horizontal portion 122 and a vertical portion 124, both of which are shown in FIG. 4. The horizontal portion 122 of the tether 74 extends rearward from the anchor 26 and into the elbow 54 formed on the pivot cover 52. The vertical portion 124 of the tether 74 extends from within the elbow 54 of the pivot cover 52 to the tether pin 112. As shown in FIGS. 3 and 4, the tether 74 is taut along both the horizontal and vertical portions 122 and 124 when extending along the first route.

Since the elbow 54 is located along the pivotal axis A of the pivot mechanism 50, pivotal movement of the backrest portion 18 of the seat 10 relative to the cushion portion 16 of the seat does not result in any tensioning or loosening of the tether 74. Moreover, the elbow 54 of the pivot cover 52 is designed to tear when subjected to a predetermined force from the tether 74. The tether 74 applies a force to the elbow 54 of the pivot cover 52 when the deflection mechanism 72 moves away from the first position and the first end of the tether 74 is moved away from the elbow 54. When the tether 74 applies the predetermined force to the elbow 54, the elbow 54 tears and no longer supports the tether 74 along the first route between the anchor 26 and the tether pin 112. Since the elbow 54 supports the tether 74 along the first route until the elbow 54 tears, a force, indicated as F_{EL} in FIG. 4, directed along the vertical portion 124 of the tether 74 aids the spring 96 in resisting rotation of the deflection mechanism 72 away from the first position.

In the event of a rear impact to the vehicle 14, the vehicle 14 is accelerated forwardly relative to the occupant 12. As a result of the vehicle 14 accelerating forwardly relative to the occupant 12, the occupant exerted force F_{OC} against the deflection plate 114 of the deflection mechanism 72 increases. When the occupant exerted force F_{OC} is greater than the sum of the spring force F_{S} and the force F_{EL} necessary to rupture the elbow 54 of the pivot cover 52, the deflection mechanism 72 begins to rotate in the counter-clockwise direction, as viewed in FIGS. 3 and 4, and away from the first position.

FIG. 5 illustrates a side view of the apparatus 8 with the occupant protection device 70 moving between an unactuated condition and an actuated condition. As the deflection mechanism 72 rotates counter-clockwise about the pivot pins 88 and 108, the lower rear vertices 84 and 104 of the right and left cranks 76 and 78, respectively, move upwardly. The upward movement of the lower rear vertex 108 of the left crank 78 tensions the tether 74 and applies a force to the elbow 54 of the pivot cover, which supports the tether 74 along the first route. When the elbow 54 of the pivot cover 52 tears, the tether 74 is free to move out of the first route and away from the elbow 54, as shown in FIG. 5. The upward movement of the lower rear vertex 84 of the right crank 76 causes the spring 96 to be stretched. As the spring 96 is stretched, the spring force F_{S} increases. If the occupant exerted force F_{OC} continues to be greater than the spring force F_{S}, the deflection mechanism 72 continues rotating in the counter-clockwise direction. If the occupant exerted force F_{OC} falls below the spring force F_{S}, the deflection mechanism 72 returns to the first position and the tether 74 hangs loosely or in a festooned manner between the anchor 26 and the tether pin 112.

Also as shown in FIG. 5, the rotation of the deflection mechanism 72 away from the first position causes the headrest portion 56 of the seat 10 to move relative to the backrest portion 18 of the seat. As the deflection mechanism 72 rotates counter-clockwise, the support bar 94 of the deflection mechanism 72 is rotated relative to the upper surface 44 of the covering 40 of the backrest portion 18 of the seat 10. The rotation of the support bar 94 of the deflection mechanism 72 causes the headrest portion 56 of the seat 10 to move forward, to the left in FIG. 5, toward the front surface 42 of the covering 40 of the backrest portion 18 and, thus, toward the head of the occupant 12 of the seat 10.

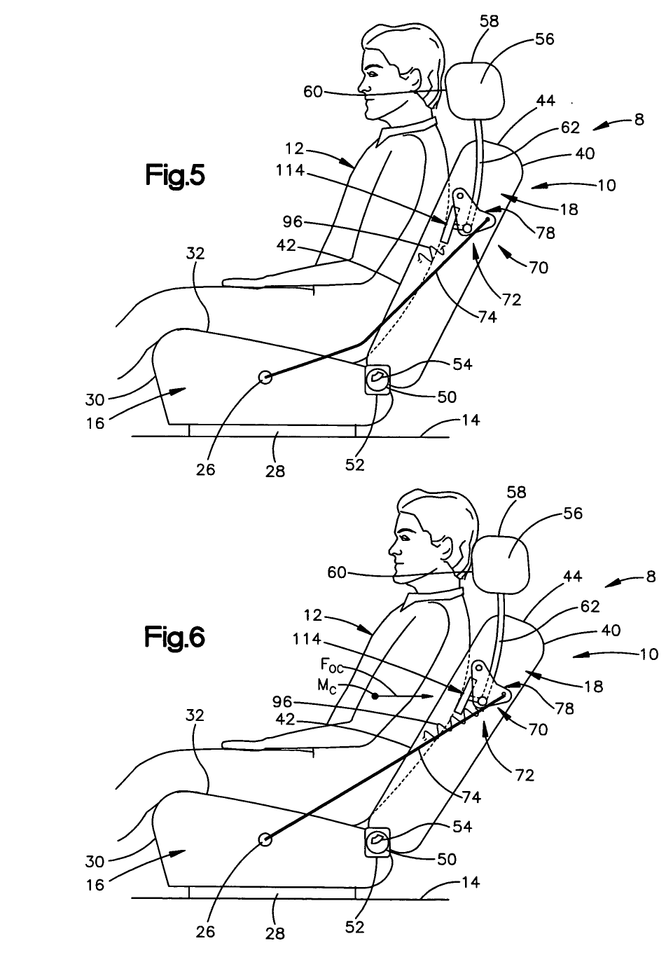

FIGS. 6 and 7 show a side view of the apparatus 8 with the actuatable occupant protection device 70 in the actuated condition. When the occupant protection device 70 is in the actuated condition, the deflection mechanism 72 is in a second position relative to the seat 10. A ratchet or locking mechanism 126, shown schematically in FIG. 2, locks the deflection mechanism 72 in the second position to lock the occupant protection device 70 in the actuated condition.

Also, when the occupant protection device 70 is in the actuated condition, the tether 74 extends along a second route between the anchor 26 and the tether pin 112. The second route is a direct route between the anchor 26 and the tether pin 112. As shown in FIGS. 6 and 7, the tether 74 is taut when extending along the second route. The tether 74, when extending along the second route, helps to prevent rearward movement of the backrest portion 18 of the seat 10 relative to the cushion portion 16 of the seat.

Moreover, when the deflection mechanism 72 is in the second position, the headrest portion 56 of the seat 10 extends forward, to the left as shown in FIG. 6, of the front surface 42 of the covering 40 of the backrest portion 18 of the seat 10. In the position shown in FIG. 6, the headrest portion 56 of the seat 10 engages and supports the head of the occupant 12 of the seat for helping to preventing injuries, such as whiplash, that may result from the rear impact to the vehicle 14.

In the event of a rear impact to the vehicle 14, the occupant exerted force F_{OC} against the deflection plate 114 of the deflection mechanism 72 may become quite large. FIG. 6 illustrates the occupant exerted force F_{OC} as being directed rearward from the center of mass M_{C} of the seated occupant. The occupant exerted force F_{OC} results in a torque T_{OC} (FIG. 7) about the pivot mechanism 50 that tends to rotate the backrest portion 18 of the seat 10 rearward, clockwise as shown in FIGS. 6 and 7, relative to the cushion portion 16 of the seat. The torque T_{OC} about the pivot mechanism 50 is defined by the following equation:

T_{OC}=F_{OC}×D

where D is the vertical distance between the pivotal axis A of the pivot mechanism 50 and the center of mass M_{C} of the seated occupant 12.

When the occupant protection device 70 is in the actuated condition, a force, indicated as F_{T} in FIG. 7, arises along the tether 74. The force F_{T} along the tether 74 helps prevent the rearward rotation of the backrest portion 18 of the seat 10 relative to the cushion portion 16 resulting from the occupant exerted force F_{OC}.

Unlike prior art seats in which the pivot mechanism alone must resist the torque T_{OC}, the actuatable occupant protection device 70 of the present invention helps to support the backrest portion 18 of the seat 10 relative to the cushion portion 16 so as to prevent rearward rotation of the backrest portion relative to the cushion portion as a result of the occupant exerted force F_{OC}. As a result, the occupant protection device 70 of the present invention enables a vehicle designer to use a lighter pivot mechanism 50. Additionally, the apparatus 8 of the present invention provides support to the head of the occupant 12 to help reduce the likelihood of head and neck injuries resulting from a rear impact to the vehicle 14.

FIG. 8 is a side view of an apparatus 8′ constructed in accordance with a second embodiment of the present invention. Structures of FIG. 8 that perform a similar function as structures described with regard to FIGS. 1-7 are indicated by the same reference numbers with the addition of a prime.

FIG. 8 illustrates the occupant protection device 70′ for the apparatus 8′ in the actuated condition. In the actuated condition, the tether pin 112′ has rotated to an over-center position relative to the pivot pin 108′. The over-center position means that during rotation of the deflection mechanism 72′ from the first position to the second position, the tether pin 112′ rotates from a first side of the pivot pin 108′ to a second side of the pivot pin with relation to a line extending between anchor 26′ and the pivot pin. As a result, the deflection mechanism 72′ is prevented from rotating toward the first position when in the second position, i.e., clockwise as shown in FIG. 8, in response to the tether force F_{T}. When the tether pin 112′ rotates to an over-center position relative to the pivot pin 108′, the ratchet mechanism 126, illustrated in FIG. 2, is unnecessary and may be eliminated.

From the above description of the invention, those skilled in the art will perceive improvements, changes and modifications. Such improvements, changes and modifications within the skill of the art are intended to be covered by the appended claims.

1-19. (cancelled)

20. An apparatus comprising:
a seat for an occupant of a vehicle, the seat comprising a cushion portion and a backrest portion, a pivot device pivotally connecting the backrest portion to the cushion portion and enabling pivotal movement of the backrest portion relative to the cushion portion in both forward and rearward directions;
an actuatable occupant protection device, the occupant protection device, when actuated, providing a forwardly directed force acting on the backrest portion of the seat to resist rearward pivotal movement of the backrest portion of the seat relative to the cushion portion of the seat; and
a mechanism that is located in the backrest portion of the seat and that is moved from a first position to a second, different position by an occupant exerted force that is directed rearward against the backrest portion of the seat, the occupant protection device being connected to the mechanism and movement of the mechanism from the first position to the second position actuating the occupant protection device, the mechanism being adapted move from the first position to the second position to actuate the occupant protection device while a relative position between the backrest portion and cushion portion of the seat is maintained.

21. The apparatus of claim 20 wherein the occupant protection device includes at least one tether, the tether extending along a first route between the cushion portion and the backrest portion when the occupant protection device is in an unactuated condition and extending along a second route, different from the first route, when the occupant protection device is in an actuated condition.

22. (Cancelled)

23. The apparatus of claim 21 wherein the cushion portion of the seat includes a cushion frame and the backrest portion of the seat includes a backrest frame, the tether connecting the cushion frame and the backrest frame.

24. (Cancelled)

25. The apparatus of claim 21 wherein the tether is made of webbing or a flexible cable.

26. The apparatus of claim 21 wherein the tether has energy absorbing characteristics.

27-28. (Cancelled)

29. An apparatus comprising:
a seat for an occupant of a vehicle, the seat including a cushion portion having a cushion frame that is mountable to the vehicle and a backrest portion having a backrest frame that is pivotally supported relative to the cushion frame for enabling forward and rearward pivotal movement of the backrest frame relative to the cushion frame;
a tether having a first condition extending along a first route between the cushion frame and the backrest frame and a second condition extending along a second route between the cushion frame and the backrest frame, the tether in the second condition resisting rearward pivotal movement of the backrest frame relative to the cushion frame resulting from a rearward force applied to the backrest portion; and
a mechanism that is located in the backrest portion of the seat and that is moved by the rearward force applied to the backrest portion of the seat, the tether being connected to the mechanism and movement of the mechanism actuating the tether from the first condition to the second condition, the mechanism being adapted to actuate the tether while a relative position between the backrest portion and cushion portion of the seat is maintained.

30. The apparatus of claim 29 wherein a pivot device pivotally connects the backrest portion of the seat to the cushion portion of the seat, the opposite ends of the tether being attached to the cushion frame and the backrest frame at locations spaced away from the pivot device.

31-35. (Cancelled)

36. The apparatus of claim 29 wherein the tether has energy absorbing characteristics.

37. An apparatus comprising:
a seat for an occupant of a vehicle, the seat comprising a cushion portion and a backrest portion, a pivot device pivotally connecting the backrest portion to the cushion portion and enabling pivotal movement of the backrest portion relative to the cushion portion in both forward and rearward directions;
an actuatable occupant protection device, the occupant protection device, when actuated, providing a forwardly directed force acting on the backrest portion of the seat to resist rearward pivotal movement of the backrest portion of the seat relative to the cushion portion of the seat, the occupant protection device including at least one tether, the tether extending along a first route between the cushion portion and the backrest portion when the occupant protection device is in an unactuated condition and extending along a second route, different from the first route, when the occupant protection device is in an actuated condition;
a mechanism that is responsive to an occupant exerted force that is directed rearward against the backrest portion of the seat for actuating the occupant protection device, the mechanism being adapted to actuate the occupant protection device while a relative position between the backrest portion and cushion portion of the seat is maintained; and
structure for supporting the tether along the first route, the structure being located along a pivotal axis of the pivot device for enabling pivotal movement of the backrest portion of the seat relative to the cushion portion of the seat while the tether extends along the first route.

38. An apparatus comprising:
a seat for an occupant of a vehicle, the seat comprising a cushion portion and a backrest portion, a pivot device pivotally connecting the backrest portion to the cushion portion and enabling pivotal movement of the backrest portion relative to the cushion portion in both forward and rearward directions;
an actuatable occupant protection device, the occupant protection device, when actuated, providing a forwardly directed force acting on the backrest portion of the seat to resist rearward pivotal movement of the backrest portion of the seat relative to the cushion portion of the seat, the occupant protection device including at least one tether, the tether extending along a first route between the cushion portion and the backrest portion when the occupant protection device is in an unactuated condition and extending along a second route, different from the first route, when the occupant protection device is in an actuated condition;
a mechanism that is responsive to an occupant exerted force that is directed rearward against the backrest portion of the seat for actuating the occupant protection device, the mechanism being adapted to actuate the occupant protection device while a relative position between the backrest portion and cushion portion of the seat is maintained; and
means for locking the occupant protection device in the actuated condition for maintaining the tether along the second route.

39. An apparatus comprising:
a seat for an occupant of a vehicle, the seat comprising a cushion portion and a backrest portion, a pivot device pivotally connecting the backrest portion to the cushion portion and enabling pivotal movement of the backrest portion relative to the cushion portion in both forward and rearward directions;
an actuatable occupant protection device, the occupant protection device, when actuated, providing a forwardly directed force acting on the backrest portion of the seat to resist rearward pivotal movement of the backrest portion of the seat relative to the cushion portion of the seat, the occupant protection device including at least one tether, the tether extending along a first route between the cushion portion and the backrest portion when the occupant protection device is in an unactuated condition and extending along a second route, different from the first route, when the occupant protection device is in an actuated condition; and
a mechanism that is responsive to an occupant exerted force that is directed rearward against the backrest portion of the seat for actuating the occupant protection device, the mechanism being adapted to actuate the occupant protection device while a relative position between the backrest portion and cushion portion of the seat is maintained,
the mechanism being pivotally connected to a backrest frame of the backrest portion of the seat and pivoting relative to the backrest frame in response to the occupant exerted force directed rearward against the backrest portion of the seat exceeding a predetermined value, the tether being attached to the mechanism and being moved from the first route to the second route during pivotal movement of the mechanism relative to the backrest frame.

40. An apparatus comprising:
a seat for an occupant of a vehicle, the seat comprising a cushion portion and a backrest portion, a pivot device pivotally connecting the backrest portion to the cushion portion and enabling pivotal movement of the backrest portion relative to the cushion portion in both forward and rearward directions;
an actuatable occupant protection device, the occupant protection device, when actuated, providing a forwardly directed force acting on the backrest portion of the seat to resist rearward pivotal movement of the backrest portion of the seat relative to the cushion portion of the seat; and
a mechanism that is responsive to an occupant exerted force that is directed rearward against the backrest portion of the seat for actuating the occupant protection device, the mechanism being adapted to actuate the occupant protection device while a relative position between the backrest portion and cushion portion of the seat is maintained,
wherein a headrest portion of the seat extends above the backrest portion of the seat and is attached to the mechanism, the headrest portion moving forward relative to the backrest portion of the seat during actuation of the occupant protection device.

41. An apparatus comprising:
a seat for an occupant of a vehicle, the seat including a cushion portion having a cushion frame that is mountable to the vehicle and a backrest portion having a backrest frame that is pivotally supported relative to the cushion frame for enabling forward and rearward pivotal movement of the backrest frame relative to the cushion frame;
a tether having a first condition extending along a first route between the cushion frame and the backrest frame and a second condition extending along a second route between the cushion frame and the backrest frame, the tether in the second condition resisting rearward pivotal movement of the backrest frame relative to the cushion frame resulting from a rearward force applied to the backrest portion; and
a mechanism that is responsive to the rearward force applied to the backrest portion of the seat for actuating the tether from the first condition to the second condition, the mechanism being adapted to actuate the tether while a relative position between the backrest portion and cushion portion of the seat is maintained,
wherein a pivot device pivotally connects the backrest portion of the seat to the cushion portion of the seat, the opposite ends of the tether being attached to the cushion frame and the backrest frame at locations spaced away from the pivot device; and
structure for supporting the tether in the first condition along the first route, the structure being located along a pivotal axis of the pivot device for enabling pivotal movement of the backrest portion of the seat relative to the cushion portion of the seat while the tether extends along the first route.

42. An apparatus comprising:
a seat for an occupant of a vehicle, the seat including a cushion portion having a cushion frame that is mountable to the vehicle and a backrest portion having a backrest frame that is pivotally supported relative to the cushion frame for enabling forward and rearward pivotal movement of the backrest frame relative to the cushion frame;
a tether having a first condition extending along a first route between the cushion frame and the backrest frame and a second condition extending along a second route between the cushion frame and the backrest frame, the tether in the second condition resisting rearward pivotal movement of the backrest frame relative to the cushion frame resulting from a rearward force applied to the backrest portion; and
a mechanism that is responsive to the rearward force applied to the backrest portion of the seat for actuating the tether from the first condition to the second condition, the mechanism being adapted to actuate the tether while a relative position between the backrest portion and cushion portion of the seat is maintained,
wherein a headrest portion of the seat extends above the backrest portion of the seat and is attached to the mechanism, the headrest portion moving forward relative to the backrest portion of the seat in response to the mechanism actuating the tether from the first condition to the second condition.

43. An apparatus comprising:
a seat for an occupant of a vehicle, the seat including a cushion portion having a cushion frame that is mountable to the vehicle and a backrest portion having a backrest frame that is pivotally supported relative to the cushion frame for enabling forward and rearward pivotal movement of the backrest frame relative to the cushion frame;
a tether having a first condition extending along a first route between the cushion frame and the backrest frame and a second condition extending along a second route between the cushion frame and the backrest frame, the tether in the second condition resisting rearward pivotal movement of the backrest frame relative to the cushion frame resulting from a rearward force applied to the backrest portion; and
a mechanism that is responsive to the rearward force applied to the backrest portion of the seat for actuating the tether from the first condition to the second condition, the mechanism being adapted to actuate the tether while a relative position between the backrest portion and cushion portion of the seat is maintained,
wherein the mechanism is pivotally connected to the backrest frame and pivots relative to the backrest frame in response to the rearward force applied to the backrest portion exceeding a predetermined value, the tether being attached to the mechanism and being moved from the first condition to the second condition during pivotal movement of the mechanism.

44. The apparatus of claim 43 further including means for locking the mechanism, after actuation of the tether from the first condition to the second condition, for maintaining the tether along the second route between the cushion frame and the backrest frame.

45. An apparatus comprising:
a seat for an occupant of a vehicle, the seat including a cushion portion having a cushion frame that is mountable to the vehicle and a backrest portion having a backrest frame that is pivotally supported relative to the cushion frame for enabling forward and rearward pivotal movement of the backrest frame relative to the cushion frame;
a tether having a first condition extending along a first route between the cushion frame and the backrest frame and a second condition extending along a second route between the cushion frame and the backrest frame, the tether in the second condition resisting rearward pivotal movement of the backrest frame relative to the cushion frame resulting from a rearward force applied to the backrest portion; and
a mechanism that is responsive to the rearward force applied to the backrest portion of the seat for actuating the tether from the first condition to the second condition, the mechanism being adapted to actuate the tether while a relative position between the backrest portion and cushion portion of the seat is maintained,
wherein the tether is made of one of webbing and a flexible cable.

46. An apparatus comprising:
a seat for an occupant of a vehicle, the seat comprising a cushion portion and a backrest portion, a pivot device pivotally connecting the backrest portion to the cushion portion and enabling pivotal movement of the backrest portion relative to the cushion portion in both forward and rearward directions;
an actuatable occupant protection device, the occupant protection device, when actuated, providing a forwardly directed force acting on the backrest portion of the seat to resist rearward pivotal movement of the backrest portion of the seat relative to the cushion portion of the seat; and
a mechanism that is located in the backrest portion of the seat and that is moved from a first position to a second, different position by an occupant exerted force that is directed rearward against the backrest portion of the seat, the occupant protection device being connected to the mechanism in the backrest portion of the seat and movement of the mechanism from the first position to the second position actuating the occupant protection device, the occupant exerted force being transferred, at least in part, to the occupant protection device, when the occupant protection device is actuated, so that the forwardly directed force provided by the occupant protection device arises from the occupant exerted force.

47. An apparatus comprising:
a seat for an occupant of a vehicle, the seat comprising a cushion portion and a backrest portion, a pivot device pivotally connecting the backrest portion to the cushion portion and enabling pivotal movement of the backrest portion relative to the cushion portion in both forward and rearward directions;
an actuatable occupant protection device, the occupant protection device, when actuated, providing a forwardly directed force acting on the backrest portion of the seat to resist rearward pivotal movement of the backrest portion of the seat relative to the cushion portion of the seat; and
a mechanism to which the occupant protection device is connected, the mechanism being responsive to an occupant exerted force that is directed rearward against the backrest portion of the seat for actuating the occupant protection device, the mechanism being adapted to actuate the occupant protection device while a relative position between the backrest portion and cushion portion of the seat is maintained, the occupant exerted force being transferred, at least in part, to the occupant protection device, when the occupant protection device is actuated, so that the forwardly directed force provided by the occupant protection device arises from the occupant exerted force.
